(19) United States
(12) Patent Application Publication
(10) Pub. No.: US 2026/0027777 A1
(43) Pub. Date: Jan. 29, 2026

(54) PACKAGING AND SUPPLY DEVICE BASED ON 3D PRINTING MATERIALS

(71) Applicant: RUN WING AUTOMATION CO., LTD., Shenzhen (CN)

(72) Inventors: Bingzhong ZHANG, Shenzhen (CN); Wenqiang HE, Shenzhen (CN); Xin LIU, Shenzhen (CN)

(73) Assignee: RUN WING AUTOMATION CO., LTD., Shenzhen, GD (CN)

(21) Appl. No.: 18/974,168

(22) Filed: Dec. 9, 2024

(30) Foreign Application Priority Data
Jul. 23, 2024 (CN) 202421754683.5

(51) Int. Cl. B29C 64/336; B33Y 40/00

(52) U.S. Cl. CPC B29C 64/336; B33Y 40/00

(57) ABSTRACT

A packaging and supply device based on 3D printing materials is provided. The device includes extrusion mechanisms and flexible bags. The extrusion mechanism includes a first extrusion roller and a second extrusion roller, a rotation direction of the first extrusion roller and a rotation direction of the second extrusion roller are opposite. An extrusion interval is formed between the first extrusion roller and the second extrusion roller. The extrusion interval includes a flexible bag inlet and a flexible bag outlet. The flexible bag inlet faces a 3D print head of a 3D printer, and a preset distance is maintained between the flexible bag inlet and the 3D print head. The flexible bag includes an initial extrusion end and a terminal extrusion end. A printing material discharge port is arranged at the terminal extrusion end. The printing material discharge port is connected to the 3D print head through a hose.

### CROSS-REFERENCE TO RELATED APPLICATION

This patent application claims the benefit and priority of Chinese Patent Application No. 2024217546835, entitled “PACKAGING AND SUPPLY DEVICE BASED ON 3D PRINTING MATERIALS” filed on Jul. 23, 2024, the disclosure of which is incorporated by reference herein in its entirety as part of the present application.

### TECHNICAL FIELD

The present disclosure relates to the field of 3D printing technology, and particularly to a packaging and supply device based on 3D printing materials.

### BACKGROUND

3D printing, also known as additive manufacturing, is a type of rapid prototyping technology that is a technique based on digital model files that constructs objects by layer-by-layer printing using powder metal or plastic and other bonding materials. In the process of 3D printing, it is necessary to supply printing materials in a timely manner to ensure the quality of the printed product.

In the feeding equipment of the existing 3D printer, 3D printing materials are often pre-stored in a material cylinder. During operation, the raw materials in the cylinder are conveyed to a large storage tank, and the bottom of the storage tank is connected to the printing device through a feeding pipe.

For example, patent CN221067212U discloses a material feeding device for 3D printing, which fixes multiple material cylinders on a turntable. Raw materials for 3D printing are loaded in the material cylinders, a storage tank is fixedly arranged inside the box body, and the volume of the storage tank is significantly larger than that of the material cylinders. When the material cylinder inside the turntable aligns with the discharge hole, the pigment inside the material cylinder enters the storage tank through the discharge hole, and is then conveyed to the 3D print head through a feeding pipe at the bottom of the storage tank.

However, when the raw materials are conveyed to the storage tank, bubbles can form between the materials. If the material containing bubbles is conveyed to the 3D print head, the print head may not receive sufficient material, seriously affecting the printing quality.

Therefore, there is an urgent need for a feeding device for 3D printing that can effectively prevent the formation of bubbles in the raw materials, ensure stable feeding, and maintain good printing quality in 3D printers.

### SUMMARY

The embodiments aim to provide a packaging and supply device based on 3D printing materials to solve the problems present in the existing technology. The device stores 3D printing materials in a flexible bag, and the first extrusion roller and the second extrusion roller extrude the materials. The extruded 3D printing materials are conveyed to the 3D print head along a hose. During the feeding process, it is not necessary to pour the 3D printing materials into a feeding cylinder first, preventing bubbles from forming between the 3D printing materials, thus improving the printing quality and efficiency. The device is also convenient for storage and transportation, and has good environmental benefits.

To achieve the above objectives, the present disclosure provides the following solution. A packaging and supply device for 3D printing materials, including: an extrusion mechanism and a flexible bag for storing 3D printing materials;

The extrusion mechanism includes a first extrusion roller and a second extrusion roller. A rotation direction of the first extrusion roller and a rotation direction of the second extrusion roller are opposite, and an extrusion interval for squeezing the flexible bags is formed between the first extrusion roller and the second extrusion roller. The extrusion interval includes a flexible bag inlet and a flexible bag outlet. The flexible bag inlet faces the 3D print head of the 3D printer, and a preset distance is maintained between the flexible bag inlet and the 3D print head.

The flexible bag includes an initial end and a terminal end, which sequentially enter the extrusion interval from the flexible bag inlet. A printing material discharge port is arranged at the terminal end. The printing material discharge port communicates with the 3D print head via a hose, and a length of the hose is not less than the preset distance.

In some embodiments, the device includes multiple flexible bags, and these multiple flexible bags are connected to the 3D print head through a multi-head communication pipe.

In some embodiments, the extrusion mechanism includes a box body. The box body is divided into two parts which are a first housing and a second housing. The first and second housings are hinged together, and notches are respectively arranged on sides of the first housing and the second housing opposite to a hinge axis. The first extrusion roller is rotatably connected to an inner wall of the first housing, and the second extrusion roller is rotatably connected to an inner wall of the second housing.

In some embodiments, a reset mechanism is arranged on the box body. The reset mechanism includes a first adjusting rod hinged to the first housing and a second adjusting rod hinged to the second housing. Both ends of the reset spring are connected to the first adjusting rod and the second adjusting rod respectively.

In some embodiments, a first driving motor for driving the first extrusion roller to rotate is arranged on an outer side wall of the first housing. An output shaft of the first driving motor is connected to the first extrusion roller. A second driving motor for driving the second extrusion roller to rotate is arranged on an outer side wall of the second housing. An output shaft of the second driving motor is connected to the second extrusion roller.

In some embodiments, the device further includes a flexible bag connector sealably connected to the printing material discharge port. An outer side wall of the flexible bag connector is sequentially provided with a slot and connector threads along a discharge path. The hose is provided with a hose connector for sealably connecting with the flexible bag connector. The hose connector is either a snap-fit hose connector or a threaded hose connector.

In some embodiments, an outer wall surface of the flexible bag connector is provided with a step for welding with the printing material discharge port. The step is arranged on a side, away from the connector threads, of the slot.

In some embodiments, the hose connector is the snap-fit hose connector. The snap-fit hose connector includes an insertion portion and a snap portion. The insertion portion includes an insertion tube for inserting into the flexible bag connector. The snap portion includes a circular flange and snaps for snap-fitting with the slot. The circular flange is arranged around an outer periphery of the insertion tube, and a plane in which the circular flange is located is perpendicular to an axis of the insertion tube. A side, facing the flexible bag, of the circular flange (34) is provided with a sealing pad for sealing the flexible bag connector. The snaps are provided multiple snaps and are arranged around an outer periphery of the circular flange.

In some embodiments, the hose connector is the threaded hose connector. The threaded hose connector includes an insertion portion and a threaded connection portion. The insertion portion includes an insertion tube for inserting into the flexible bag connector. The threaded connection portion includes a circular flange and an annular housing for engaging with the connector threads. The circular flange is arranged around an outer periphery of the insertion tube, and a plane in which the circular flange is located is perpendicular to an axis of the insertion tube. A a side, facing the flexible bag, of the circular flange is provided with a sealing pad for sealing the flexible bag connector. The annular housing is arranged around an outer periphery of the circular flange, and an inner wall surface of the annular housing is provided with internal threads.

In some embodiments, both an outer side wall of each of the snap-fit hose connector and the threaded hose connector is provided with a spare discharge port.

Compared with the prior art, the embodiments have achieved the following technical effects.

By storing 3D printing materials in a flexible bag, and clamping the flexible bag between the first extrusion roller and the second extrusion roller, the 3D printing materials inside the packaging bag are extruded by the first extrusion roller and the second extrusion roller. The extruded 3D printing materials are conveyed to the 3D print head along a hose. During the feeding process, it is not necessary to pour the 3D printing materials into a feeding cylinder first and then convey them to the 3D print head. The 3D printing materials in the embodiments have a small contact area with the air during the conveying process, and the flow process of the 3D printing materials is stable. Moreover, it is not necessary to transfer the 3D printing materials to a third-party feeding device, such that the 3D printing materials will not undergo significant disturbance and mixing with air, preventing the formation of bubbles between the 3D printing materials. At the same time, the automatic extrusion of 3D printing materials can be completed, improving printing quality and efficiency, and facilitating storage and transportation. The production cost is low, and the used packaging can be recycled for repeated use or conveniently disposed of in an environmentally friendly manner.

### BRIEF DESCRIPTION OF THE DRAWINGS

To more clearly illustrate the technical solutions of the embodiments of the present disclosure or the prior art, the drawings used in the embodiments will be briefly introduced below. It is evident that the following drawings are merely some embodiments of the present disclosure. For those skilled in the art, other drawings can also be derived from these drawings without any creative effort.

FIG. 1 is a schematic diagram of the overall structure according to the present disclosure.

FIG. 2 is a schematic diagram of the structure of the extrusion mechanism according to the present disclosure.

FIG. 3 is a schematic diagram of the structure of the first housing according to the present disclosure.

FIG. 4 is a schematic diagram of the structure of the second housing according to the present disclosure.

FIG. 5 is a sectional view of the structure of the flexible bag according to the present disclosure.

FIG. 6 is a schematic diagram of the structure of the multi-head communication pipe according to the present disclosure.

FIG. 7 is another perspective sectional view of the structure of the flexible bag according to the present disclosure.

FIG. 8 is a schematic diagram of the extrusion mechanism in another state according to the present disclosure.

FIG. 9 is a schematic diagram of the structure of the protrusion portion according to the present disclosure.

FIG. 10 is a schematic diagram of the profile structure according to the present disclosure.

FIG. 11 is a schematic diagram of the connection structure of the flexible bag according to the present disclosure.

FIG. 12 is a schematic diagram of the structure of the flexible bag connector according to the present disclosure.

FIG. 13 is a schematic diagram of the structure of the snap-fit hose connector according to the present disclosure.

FIG. 14 is a schematic diagram of the structure of the threaded hose connector according to the present disclosure.

FIG. 15 is a sectional view of the structure of the threaded hose connector of the present disclosure.

FIG. 16 is a schematic diagram of the structure of the supply solenoid valve according to the present disclosure.

FIG. 17 is a front view schematic diagram according to another embodiment of the present disclosure.

FIG. 18 is a schematic diagram of the overall structure according to another embodiment of the present disclosure.

List of the reference characters: 1 extrusion mechanism; 2 flexible bag; 3 first extrusion roller; 4 second extrusion roller; 5 printing material discharge port; 6 hose; 7 flow guiding section; 8 edge strip; 9 multi-head connecting pipe; 10 connecting pipe main body; 11 hose insertion port; 12 pressure sensor; 13 first housing; 14 second housing; 15 notch; 16 hinge; 17 fixing portion; 18 hinging portion; 19 first adjustment rod; 20 second adjustment rod; 21 reset spring; 22 first drive motor; 23 second drive motor; 24 protrusion; 25 support frame; 26 profile; 27 flexible bag connector; 28 slot; 29 connector thread; 30 hose connector; 31 snap-fit hose connector; 32 threaded hose connector; 33 insertion tube; 34 circular flange; 35 snap; 36 step; 37 sealing pad; 38 annular housing; 39 internal thread; 40 auxiliary discharge port; 41 material feed valve; 42 exhaust solenoid valve; 43 first storage chamber; 44 second storage chamber; 45 third storage chamber; and 46 flexible bag converging pipe.

### DETAILED DESCRIPTION OF THE EMBODIMENTS

The following detailed description, with reference to the accompanying drawings of the embodiments of the present disclosure, will provide a clear and complete explanation of the technical solution. It is evident that the described embodiments are merely a part of the embodiments of the present disclosure and not all possible embodiments. All other embodiments that those skilled in the art may derive from the present disclosure without inventive effort fall within the scope of protection of the present disclosure.

To make the objectives, features, and advantages of the present disclosure more apparent and understandable, the following detailed description in conjunction with the drawings and specific embodiments of the present disclosure will be provided.

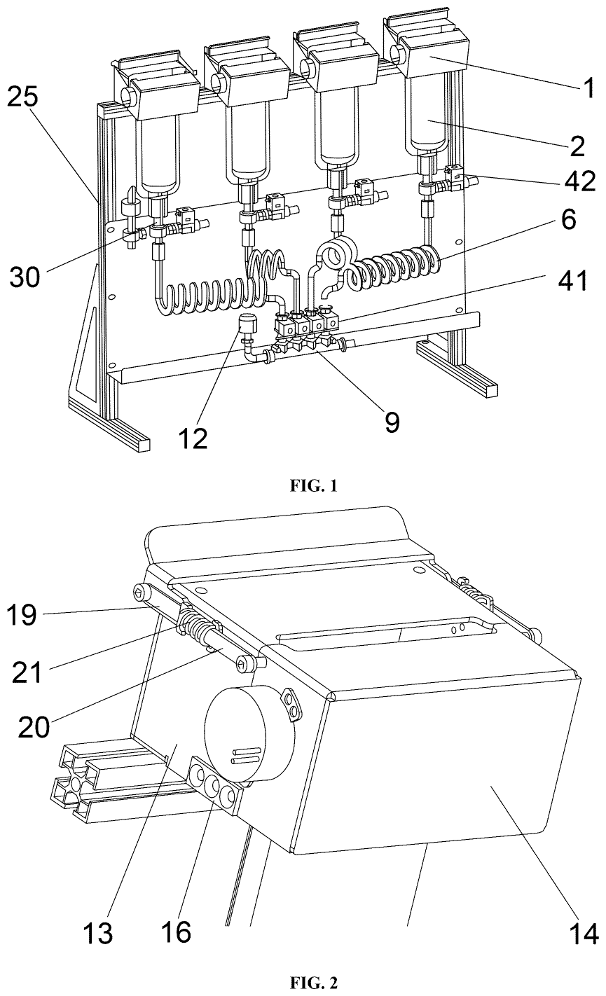

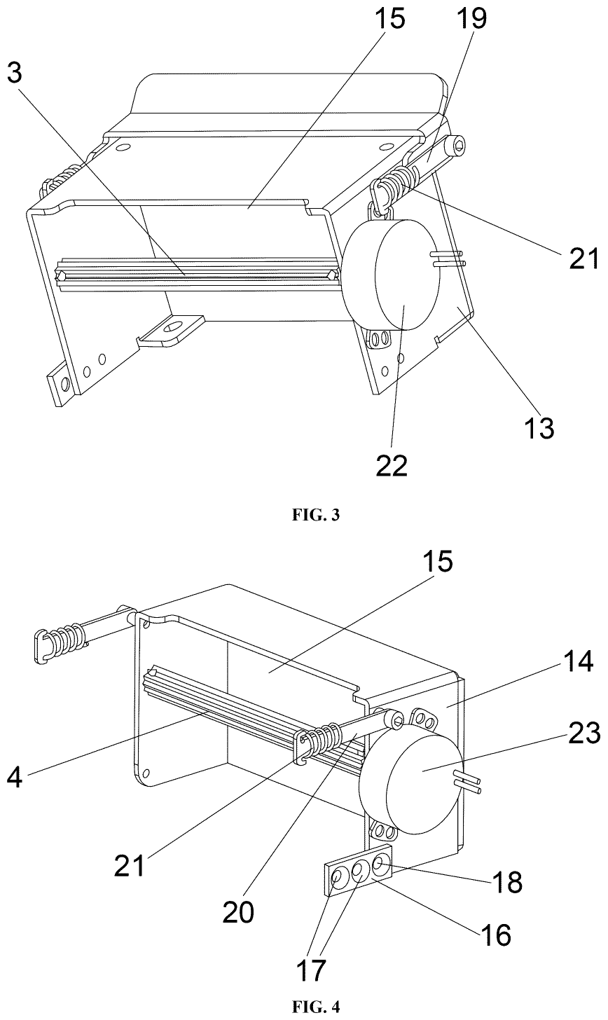

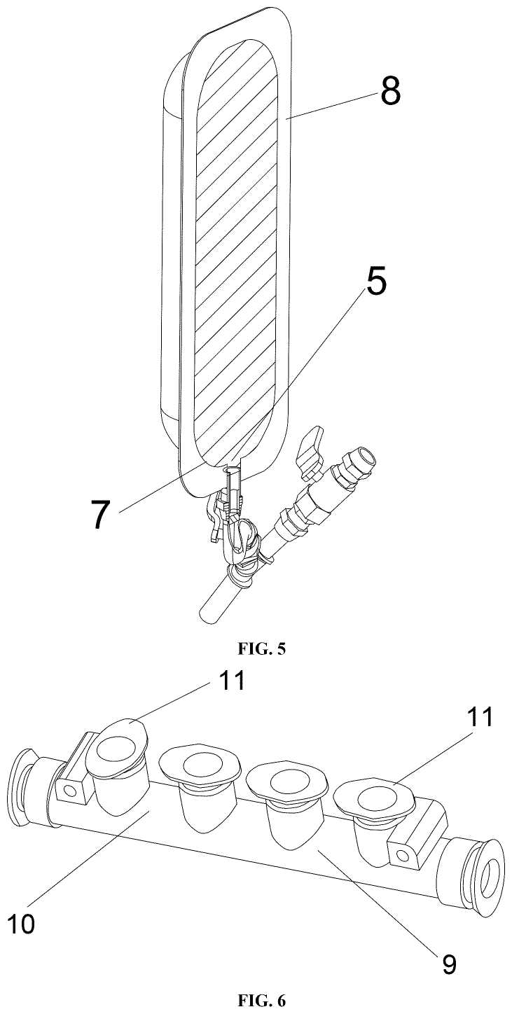

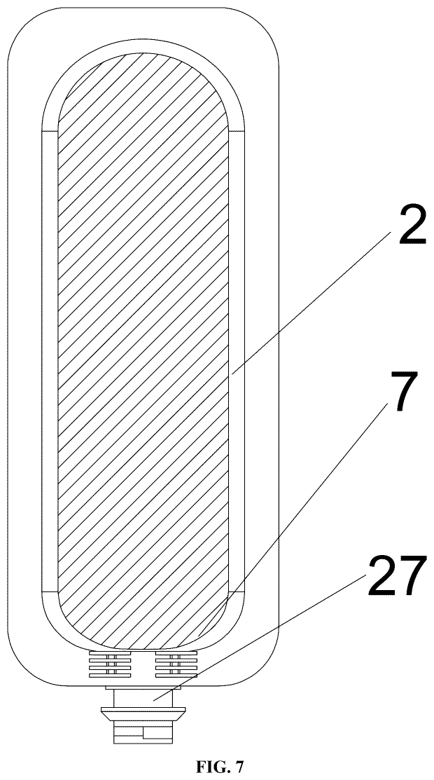

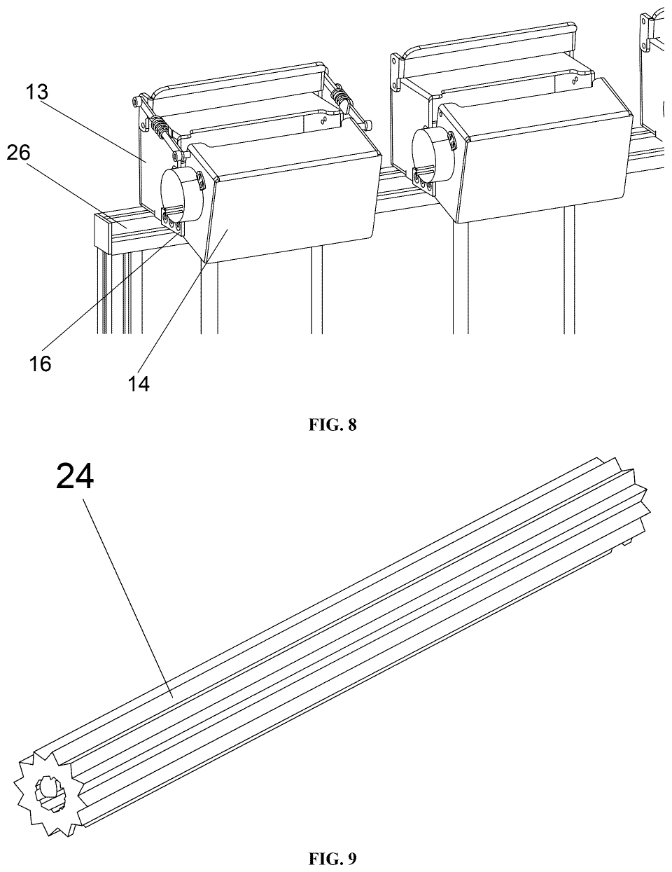

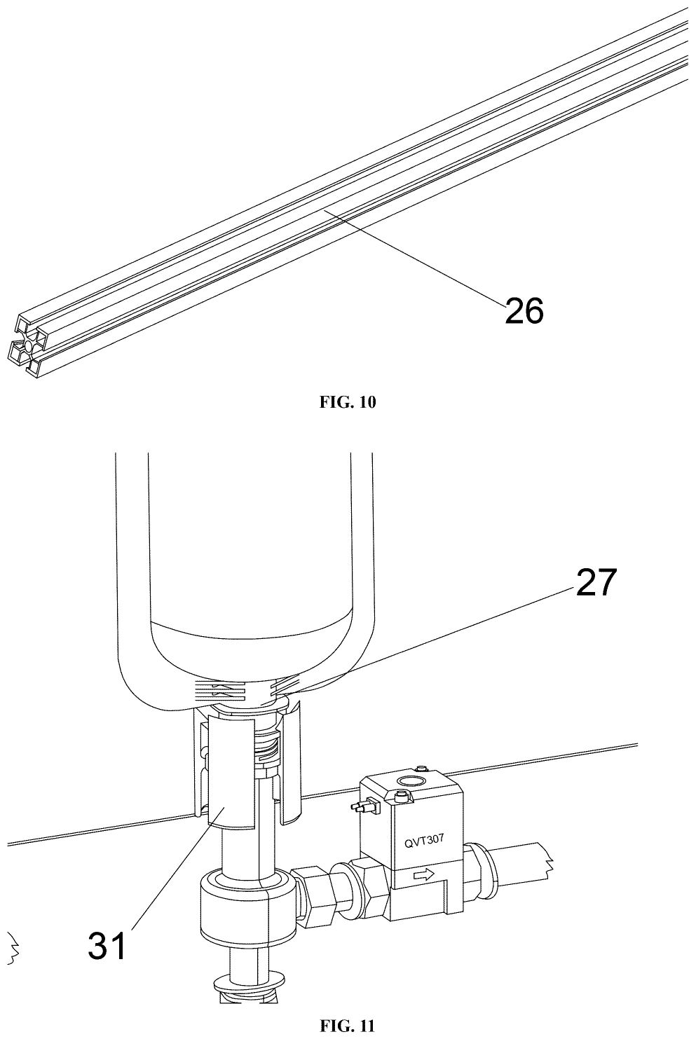

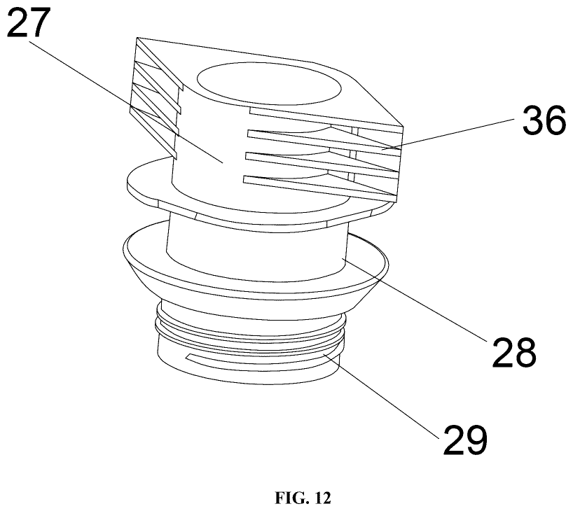

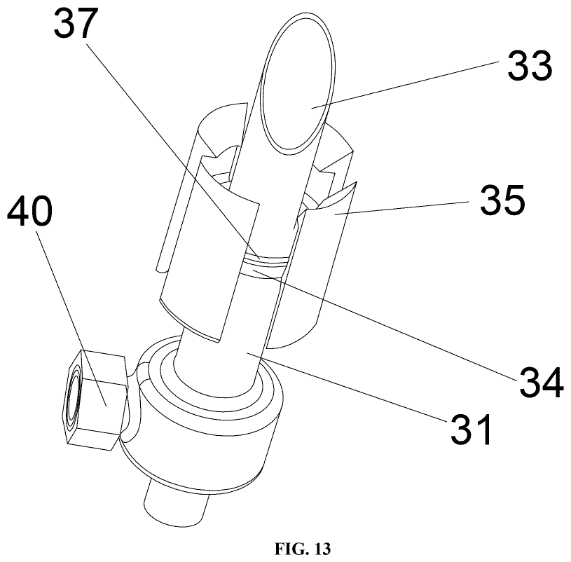

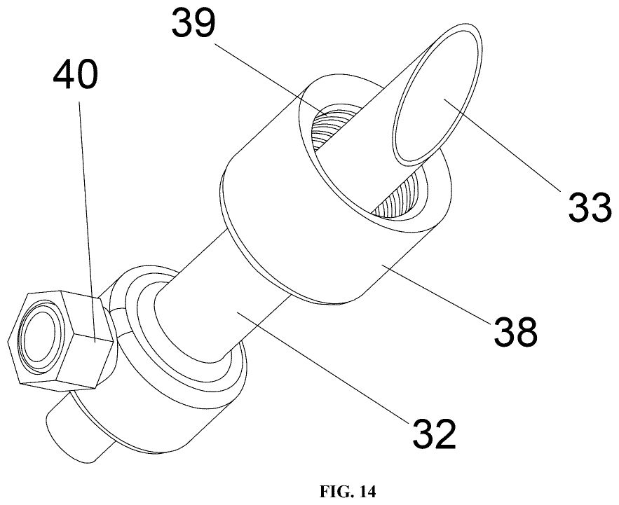

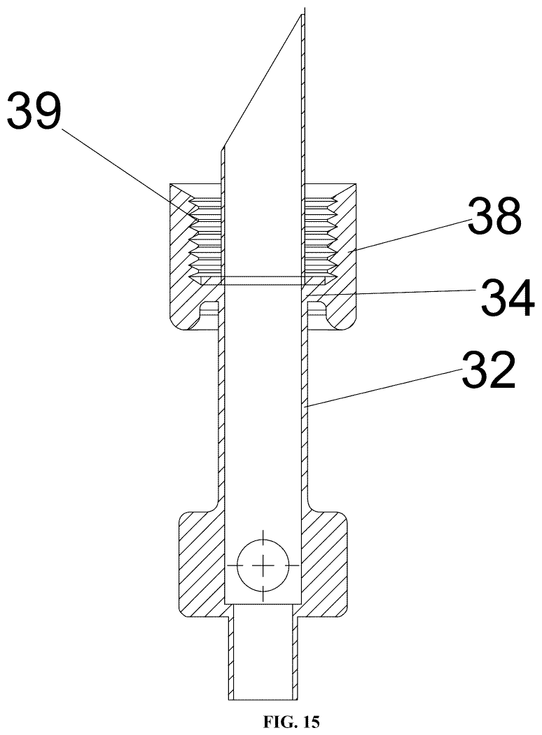

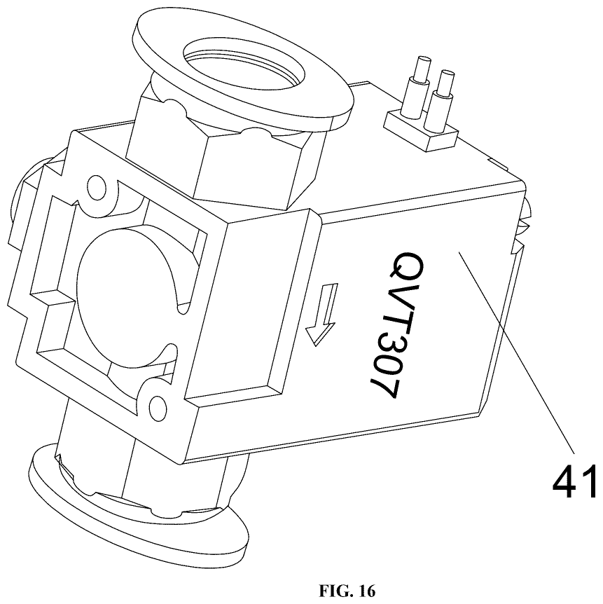

With reference to FIG. 1 to FIG. 18, the embodiment provided herein describes a packaging and supply device based on 3D printing materials. The device includes extrusion mechanism 1 and a flexible bag 2. The flexible bag 2 serves as the packaging for the 3D printing material, allowing for the storage of the 3D printing material. The extrusion mechanism 1 includes a first extrusion roller 3 and a second extrusion roller 4, with the rotational direction of the first extrusion roller 3 and the rotational direction of the second extrusion roller 4 being opposite. The first extrusion roller 3 and the second extrusion roller 4 are positioned adjacent to each other, and preferably, the first extrusion roller 3 is parallel to the second extrusion roller 4. An extrusion zone is formed between the first extrusion roller 3 and the second extrusion roller 4. This extrusion zone includes a flexible bag inlet and a flexible bag outlet. The flexible bag inlet and the flexible bag outlet are arranged sequentially along the rotational direction of the first extrusion roller 3 and the rotational direction of the second extrusion roller 4. Specifically, the flexible bag inlet is positioned on the side where the first extrusion roller 3 and the second extrusion roller 4 approach each other in the rotational direction, and the flexible bag outlet is located on the side where the first extrusion roller 3 and the second extrusion roller 4 move away from each other in the rotational direction. The 3D printer includes a 3D print head, and the flexible bag inlet faces the 3D print head. A preset distance is maintained between the flexible bag inlet and the 3D print head, which can be adjusted according to actual conditions. The flexible bag 2 includes an extrusion start end and an extrusion end. The flexible bag 2 enters the extrusion zone through the flexible bag inlet from the extrusion start end. A printing material discharge port 5 is provided at the position of the extrusion end of the flexible bag 2. A hose 6 connects the printing material discharge port 5 to the 3D print head, with the length of the hose 6 being not less than the preset distance between the flexible bag inlet and the 3D print head.

The working Principle is as follows. The initial extrusion end of the flexible bag 2 is placed into the extrusion zone between the first extrusion roller 3 and the second extrusion roller 4. The first extrusion roller 3 and the second extrusion roller 4 are then operated to force the 3D printing material within the flexible bag 2 to be expelled through the printing material discharge port 5 into the hose 6. The 3D printing material is then transported through the hose 6 to the print head of the 3D printer for the 3D printing operation. As the first extrusion roller 3 and the second extrusion roller 4 operate, the flexible bag 2 continuously moves within the extrusion zone, with the extrusion end of the flexible bag 2 progressively approaching the flexible bag inlet of the extrusion zone. When the extrusion end of the flexible bag 2 coincides with the flexible bag inlet, it indicates that the 3D printing material stored in the flexible bag 2 has been fully extruded. During this process, the initial extrusion end of the flexible bag 2 is a dynamic end, which is always located at the position where the flexible bag 2 coincides with the flexible bag inlet of the extrusion zone. Moreover, since the length of the hose 6 is not less than the preset distance between the flexible bag inlet and the 3D print head, the displacement or elastic deformation of the hose 6 ensures that the 3D printing material from the flexible bag 2 can be stably transported to the 3D print head even as the flexible bag 2 moves under compression.

The present disclosure stores the 3D printing material in the flexible bag 2 which is clamped between the first extrusion roller 3 and the second extrusion roller 4. The first extrusion roller 3 and the second extrusion roller 4 then extrude the 3D printing material from the packaging bag, and the extruded 3D printing material is conveyed through the hose 6 to the 3D print head. During the feeding process, there is no need to first transfer the 3D printing material into a feeding cylinder before delivering it to the 3D print head. The 3D printing material in the present disclosure has minimal contact with air during transport, resulting in a stable flow process without significant disturbance or mixing with air. This prevents the formation of bubbles in the 3D printing material and facilitates automatic extrusion, improving both printing quality and efficiency. The feeding device utilizes roller shafts to directly compress the material package and employs flexible packaging material, which simplifies storage and transportation, significantly reducing costs. The used packaging can be recycled for repeated use or conveniently disposed of in an environmentally friendly manner. Furthermore, the 3D printing material in the flexible bag 2 is delivered directly to the 3D print head without transferring it to other storage devices. The flexible bags 2 can be directly used with the feeding device without requiring packaging changes or transferring materials to third-party feeding devices, thereby avoiding contamination or bubble formation in the 3D printing material. Additionally, during transportation and storage, the flexible bag 2 can adaptively change in flexibility, mitigating potential issues caused by shrinkage or expansion during these processes.

In one embodiment, a flow guiding section 7 is provided within the flexible bag 2. The flow guiding section 7 is in communication with the printing material discharge port 5. One end of the flow guiding section 7 is engaged with the inner wall of the flexible bag 2 and is gradually narrows towards the printing material discharge port 5. The flow guiding section 7 has a “trumpet-shaped” structure, that is, the opening of the flow guiding section 7 on the side more adjacent to the interior of the flexible bag 2 is larger, and progressively becomes smaller as it approaches the printing material discharge port 5. The flow guiding section 7 facilitates the complete extrusion of the 3D printing material from the flexible bag 2, reducing the amount of 3D printing material remaining in the corners of the flexible bag 2.

In this embodiment, the flexible bag 2 is uniformly perforated with micropore structures that are not visible to the naked eye and can pass through air or oxygen. Moreover, the micropores do not cause leakage of the 3D printing material from the flexible bag 2, and play an oxygen inhibition role (oxygen obstructs polymerization) for light-curing materials. the micropore structures can prevent the solidification of the 3D printing material and improves the stability of storage and transportation processes.

In this embodiment, edge strips 8 are arranged around the outer periphery of the flexible bag 2. The flexible bag 2 is symmetric with respect to the plane in which the edge strips 8 are located. When initially inserting the flexible bag 2 into the extrusion zone, the edge strips 8 are placed into the extrusion zone first. Starting the extrusion from the position of the edge strips 8 can ensure that the 3D printing material within the flexible bag 2 is fully extruded.

In one embodiment, multiple flexible bags 2 are provided. These multiple flexible bags 2 are connected to the 3D print head via a multi-head connecting pipe 9. The multi-head connecting pipe 9 includes a connecting pipe main body 10, which is equipped with multiple hose insertion ports 11. Each hose insertion port 11 connects to the corresponding hose 6 of the flexible bag 2. Preferably, the hose insertion ports 11 are uniformly arranged along the axis of the connecting pipe main body 10 in sequence. The diameter of the connecting pipe main body 10, the diameter of the hose insertion ports 11 and the diameter of the hose 6 are the same or similar. When the 3D printing material is fed through the hose 6 into the connecting pipe main body 10, the 3D printing material fills the interior of the connecting pipe main body 10 and the hose insertion ports 11, and the 3D printing material will not be greatly disturbed, thereby reducing the formation of bubbles in the 3D printing material. The multi-head connecting pipe 9 is connected to a pressure sensor 12 which monitors the pressure within the multi-head connecting pipe 9.

In another embodiment, the extrusion mechanism 1 includes a box-like structure that is divided into two parts including a first housing 13 and a second housing 14. The first housing 13 and the second housing 14 are hinged together, with the hinge axis located on the sidewalls of the first and second housings.

The first housing 13 and the second housing 14 have openings on the end facing the hose 6, facilitating the insertion or removal of the flexible bag 2 from the bottom of the first and second housings. Additionally, both the first housing 13 and the second housing 14 are respectively provided with notches 15, located on the sides opposite the hinge axis. The first extrusion roller 3 is rotatably connected to the inner wall of the first housing 13, and the second extrusion roller 4 is rotatably connected to the inner wall of the second housing 14. When the first housing 13 and the second housing 14 are separated, a larger-sized access opening is formed between the two notches 15, allowing the flexible bag 2 to be inserted or removed through the access opening.

Preferably, the device further includes a hinge 16, which is fixedly connected to the first housing 13 and rotatably connected to the second housing 14. The hinge 16 has a plate-like structure and is located at the bottom end of the first housing and the second housing. The hinge 16 includes two fixing portions 17 and one hinging portion 18. The hinge 16 is fixedly connected to the first housing 13 via the two fixing portions 17, preferably fixed by bolts, and is hinged to the second housing 14 via the hinging portion 18, thereby achieving the opening and closing of the first housing 13 and the second housing 14.

In this embodiment, a reset mechanism is provided on the box-like structure. The reset mechanism includes a first adjustment rod 19 and a second adjustment rod 20. The first adjustment rod 19 is hinged to the outer side wall of the first housing 13, and the second adjustment rod 20 is hinged to the outer side wall of the second housing 14. A reset spring 21 connects the first adjustment rod 19 and the second adjustment rod 20. When an external force is applied to the first housing 13 or the second housing 14, causing them to open, the first adjustment rod 19 and the second adjustment rod 20 move relative to each other, compressing the reset spring 21. When the external force is removed, the reset spring 21 returns to its original shape, pulling the first adjustment rod 19 and the second adjustment rod 20 to move relative to each other, thereby causing the first housing 13 and the second housing 14 are in contact. Preferably, the first adjustment rod 19 and the second adjustment rod 20 have overlapping sections, with the reset spring 21 mounted on the overlapping sections of the first adjustment rod 19 and the second adjustment rod 20. The reset spring 21 ensures that the first housing 13 and the second housing 14 remain in a closed state.

In this embodiment, a first drive motor 22 is mounted on the outer side wall of the first housing 13, with the output shaft of the first drive motor 22 connected to the first extrusion roller 3. Similarly, a second drive motor 23 is mounted on the outer side wall of the second housing 14, with the output shaft of the second drive motor 23 connected to the second extrusion roller 4. Preferably, splines are provided inside the first extrusion roller 3 and the second extrusion roller 4, with the output shafts connecting to the first and second extrusion rollers 3 and 4 via the splines. Additionally, preferably, protrusions 24 are provided on the outer side walls of the first extrusion roller 3 and the second extrusion roller 4. These protrusions 24 are uniformly arranged circumferentially around the outer side walls of the first extrusion roller 3 and the second extrusion roller 4, and grooves are formed between every two adjacent protrusions 24. The protrusions 24 on adjacent extrusion rollers engage with the grooves, allowing the protrusions 24 to fit into the grooves, thereby facilitating the extrusion of the flexible bag 2.

In this embodiment, a support frame 25 is further included, which supports the extrusion mechanism 1, the flexible bag 2, and the hose 6. Multiple extrusion mechanisms 1 and flexible bags 2 can be fixed to the support frame 25. The support frame 25 includes a profile 26, preferably located at the top of the support frame 25. The length of the profile 26 can be selected according to the specific use scenario. The first housing 13 is fixed to the profile 26, and preferably, the first housing 13 can be directly inserted into the profile 26, with the position of the first housing 13 on the profile 26 being adjustable.

In one embodiment, a flexible bag connector 27 is included, which is sealingly connected to the printing material discharge port 5. Preferably, the flexible bag connector 27 is fused to the printing material discharge port 5. The outer side wall of the flexible bag connector 27 is provided with a slot 28 and connector threads 29, which are arranged sequentially along the material transfer path of the flexible bag connector 27. The connector threads 29 are located at the end of the flexible bag connector 27. A hose connector 30 is provided on the hose 6, with the hose 6 being an airtight connection to the hose connector 30. Preferably, the hose 6 is fused to the hose connector 30. The hose connector 30 may be either a snap-fit hose connector 31 or a threaded hose connector 32. The snap-fit hose connector 31 can engage with the slot 28, while the threaded hose connector 32 can be threadedly connected to the connector thread 29.

In this embodiment, a step 36 is provided on the outer wall surface of the flexible bag connector 27. The step 36 is located on the side, away from the connector thread 29, of the slot 28. The step 36 is arranged around the outer wall surface of the flexible bag connector 27 and is divided into three tiers. The topmost tier of the step 36 is flush with the end surface of the flexible bag connector 27, allowing for direct fusion with the flexible bag 2. This ensures a stable connection between the flexible bag 2 and the flexible bag connector 27.

In one embodiment, when the hose connector 30 is a snap-fit hose connector 31, the snap-fit hose connector 31 includes an insertion portion and a snap portion. The insertion portion includes an insertion tube 33 which is inserted into the flexible bag connector 27. The 3D printing material output from the flexible bag connector 27 flows into the insertion tube 33. The snap portion includes a circular flange 34 and a snap 35. The snap 35 is arranged around the outer perimeter of the circular flange 34 and engages with the slot 28, thereby connecting the snap-fit hose connector 31 with the flexible bag connector 27. A sealing pad 37 is provided on one side of the circular flange 34, with the sealing pad 37 abutting the discharge end of the flexible bag connector 27, forming a seal between the flexible bag connector 27 and the snap-fit hose connector 31. This ensures that all 3D printing material output from the flexible bag connector 27 flows into the snap-fit hose connector 31.

In the embodiment, when the hose connector 30 is a threaded hose connector 32, the threaded hose connector 32 includes an insertion portion and a threaded connection portion. The insertion portion includes an insertion tube 33 which is inserted into the flexible bag connector 27. The threaded connection part includes a circular flange 34 and an annular housing 38. The annular housing 38 surrounds the outer perimeter of the circular flange 34, with the plane in which the circular flange 34 is located being perpendicular to the axis of the insertion tube 33. A sealing pad 37 is provided on one side of the circular flange 34, with the sealing pad 37 abutting the discharge end of the flexible bag connector 27, forming a seal between the flexible bag connector 27 and the threaded hose connector 32. The inner wall of the annular housing 38 is provided with internal threads 39, and the annular housing 38 is connected to the flexible bag connector 27 via the internal threads 39.

By using the snap-fit hose connector 31 and the threaded hose connector 32 with the flexible bag connector 27, a stable and sealed connection between the flexible bag 2 and the hose 6 can be achieved, and both the installation and removal processes are simple and convenient.

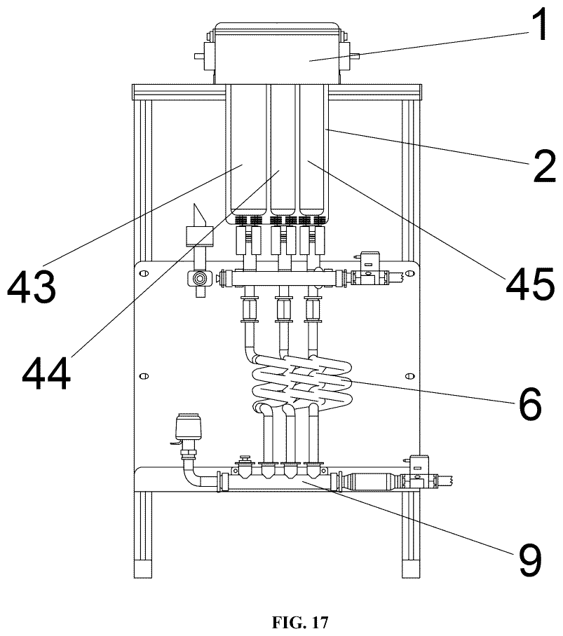

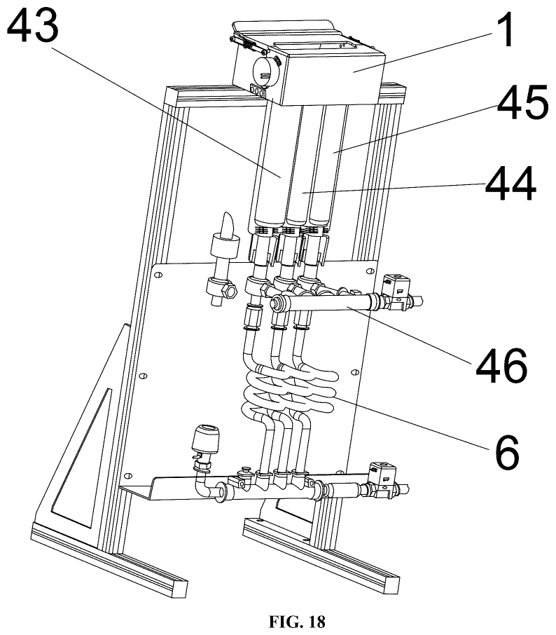

In one embodiment, as shown in FIGS. 17 and 18, the snap-fit hose connector 31 and the threaded hose connector 32 each have an auxiliary discharge port 40 on their outer sidewalls. An auxiliary discharge channel is provided within the auxiliary discharge port 40, allowing the snap-fit hose connector 31 and the threaded hose connector 32 to form a three-way valve. The auxiliary discharge port 40 can communicate with another flexible bag 2 and the flexible bag connector 27. When the 3D printing material in one flexible bag 2 is completely extruded, the 3D printing material in another connected flexible bag 2 can continue to supply material, enabling uninterrupted feeding. Additionally, during material replacement, the auxiliary discharge port 40 can preemptively release any residual air before feeding, thereby facilitating error prevention. The auxiliary discharge port 40 is further connected to an exhaust solenoid valve 42.

In one embodiment, as shown in FIGS. 17 and 18, the flexible bag 2 contains three storage chambers for holding 3D printing materials, that are a first storage chamber 43, a second storage chamber 44 and a third storage chamber 45. Each of these storage chambers is connected to the communication pipe main body 10 via the flexible bag connector 27, the hose connector 30 and the hose 6. Each hose connector 30 corresponding to the first storage chamber 43, the second storage chamber 44 and the third storage chamber 45 communicates with a flexible bag converging pipe 46. Preferably, the flexible bag converging pipe 46 has a structure consistent with that of the communication pipe main body 10. The end of the flexible bag converging pipe 46 is connected to the auxiliary discharge port 40 which is further connected to an exhaust solenoid valve 42. Different colors of 3D printing materials are stored in the first storage chamber 43, the second storage chamber 44 and the third storage chamber 45, facilitating color adjustments during subsequent printing. Preferably, the volume of the first storage chamber 43, the volume of the second storage chamber 44 and the volume of the third storage chamber 45 are different, that is, within one flexible bag 2, three storage chambers for different components are formed. This multi-component proportion packaging design facilitates the use of various component ratios and plays a role in preventing errors.

In one embodiment, a material feed valve 41 is further connected between the hose inlet 11 of the multi-head connecting pipe 9 and the hose 6. The material feed valve 41 allows for the control of the feeding rate. Different colors of 3D printing materials can be filled in each flexible bag 2, or different colors of 3D printing materials can be stored in each storage chamber. The material feed valve 41 controls the discharge from each flexible bag 2, thereby allowing the color of the 3D printing material in the multi-head connecting pipe 9 to be controlled, and enabling the printing of workpieces in different colors. Furthermore, by controlling the effective amount of material output from each flexible bag 2 to the 3D printer head, the proportion of different colors of 3D printing materials can be adjusted in real-time, allowing for the 3D printing of gradient-colored workpieces. The 3D printing feeding system of the present disclosure connects the hose 6 to the flexible bag 2 and offers options for snap-fit hose connectors 31 and threaded hose connectors 32. The standardized and simple interface facilitates automation and unmanned operations, making the installation and use processes quick, simple, economical and reliable. This system meets the requirement for bubble-free raw materials during 3D printing and enables contamination-free operation. Multiple feeding mechanisms connected to the multi-head connecting pipe 9 allow for the selection of single-head or multi-head feeding, achieving continuous feeding without stopping the machine, and enabling online switching of different colors, materials and characteristics, thereby achieving intelligent material changes, saving material change time and addressing common issues in the 3D printing industry.

It should be noted that those skilled in the art will recognize that the present disclosure is not limited to the details of the exemplary embodiments described above. Other specific forms of the present disclosure can be implemented without departing from the spirit or essential characteristics of the invention. Therefore, the embodiments should be considered illustrative and not restrictive, and the scope of the present disclosure is defined by the appended claims rather than the detailed description. All variations falling within the meaning and range of equivalency of the claims are intended to be encompassed by the present disclosure. No reference signs in the claims should be construed as limiting the claims.

The present disclosure has elucidated the principles and embodiments of the invention through specific examples. The description of the above embodiments is intended to aid in understanding the method and core ideas of the present disclosure. Those skilled in the art may make modifications to the specific embodiments and applications based on the principles of the present disclosure. Thus, the contents of this specification should not be interpreted as limiting the present disclosure.

What is claimed is:

1. A packaging and supply device for 3D printing materials, comprising: an extrusion mechanism (1) and a flexible bag (2) for storing 3D printing materials;
wherein the extrusion mechanism (1) comprises a first extrusion roller (3) and a second extrusion roller (4), a rotation direction of the first extrusion roller (3) and a rotation direction of the second extrusion roller (4) are opposite, and an extrusion interval for squeezing the flexible bag (2) is formed between the first extrusion roller (3) and the second extrusion roller (4), the extrusion interval comprises a flexible bag inlet and a flexible bag outlet, the flexible bag inlet faces a 3D print head of a 3D printer, and a preset distance is maintained between the flexible bag inlet and the 3D print head; and
wherein the flexible bag (2) comprises an initial extrusion end and a terminal extrusion end, which sequentially enter the extrusion interval from the flexible bag inlet, and a printing material discharge port (5) is arranged at the terminal extrusion end; wherein the printing material discharge port (5) communicates with the 3D print head through a hose (6), and a length of the hose (6) is not less than the preset distance.

2. The packaging and supply device for 3D printing materials according to claim 1, comprising a plurality of flexible bags (2), wherein the multiple flexible bags (2) are connected to the 3D print head through a multi-head connecting pipe (9).

3. The packaging and supply device for 3D printing materials according to claim 1, wherein the extrusion mechanism (1) comprises a box body, the box body is divided into two parts which are a first housing (13) and a second housing (14), the first housing (13) and the second housing (14) are hinged together, with notches (15) respectively provided on sides of the first housing (13) and the second housing (14) opposite to a hinge axis, the first extrusion roller (3) is rotatably connected to an inner wall of the first housing (13), and the second extrusion roller (4) is rotatably connected to an inner wall of the second housing (14).

4. The packaging and supply device for 3D printing materials according to claim 3, wherein a reset mechanism is provided on the box body, the reset mechanism comprises a first adjustment rod (19) hinged to the first housing (13) and a second adjustment rod (20) hinged to the second housing (14), with both ends of a reset spring (21) are connected to the first adjustment rod (19) and the second adjustment rod (20) respectively.

5. The packaging and supply device for 3D printing materials according to claim 4, wherein a first drive motor (22) for driving the first extrusion roller (3) to rotate is provided on an outer side wall of the first housing (13), an output shaft of the first drive motor (22) is connected to the first extrusion roller (3), and a second drive motor (23) for driving the second extrusion roller (4) to rotate is provided on an outer side wall of the second housing (14), and an output shaft of the second drive motor (23) is connected to the second extrusion roller (4).

6. The packaging and supply device for 3D printing materials according to claim 1, further comprising a flexible bag connector (27) sealably connected to the printing material discharge port (5), wherein an outer side wall of the flexible bag connector (27) is sequentially provided with a slot (28) and connector threads (29) along a discharge path, and the hose (6) is provided with a hose connector (30) for sealably connecting with the flexible bag connector (27), and the hose connector (30) is either a snap-fit hose connector (31) or a threaded hose connector (32).

7. The packaging and supply device for 3D printing materials according to claim 6, wherein an outer wall surface of the flexible bag connector (27) is provided with a step (36) for welding with the printing material discharge port (5), and the step (36) is arranged on a side, away from the connector threads (29), of the slot (28).

8. The packaging and supply device for 3D printing materials according to claim 6, wherein the hose connector (30) is the snap-fit hose connector (31), the snap-fit hose connector (31) comprises an insertion portion and a snap-fit portion, the insertion portion comprises an insertion tube (33) for inserting into the flexible bag connector (27), and the snap-fit portion comprises a circular flange (34) and snaps (35) for snap-fitting with the slot (28), the circular flange (34) is arranged around an outer periphery of the insertion tube (33), a plane in which the circular flange (34) is located is perpendicular to an axis of the insertion tube (33), and a side, facing the flexible bag (2), of the circular flange (34) is provided with a sealing pad (37) for sealing the flexible bag connector (27); the snaps (35) are provided a plurality of snaps and are arranged around an outer periphery of the circular flange (34).

9. The packaging and supply device for 3D printing materials according to claim 6, wherein the hose connector (30) is the threaded hose connector (32), the threaded hose connector (32) comprises an insertion portion and a threaded connection portion, the insertion portion comprises an insertion tube (33) for inserting into the flexible bag connector (27), the threaded connection portion comprises a circular flange (34) and an annular housing (38) for connecting with the connector threads (29), the circular flange (34) is arranged around an outer periphery of the insertion tube (33), a plane in which the circular flange (34) is located is perpendicular to an axis of the insertion tube (33), and a side, facing the flexible bag (2), of the circular flange (34) is provided with a sealing pad (37) for sealing the flexible bag connector (27); the annular housing (38) is arranged around an outer periphery of the circular flange (34), and an inner wall surface of the annular housing (38) is provided with internal threads (39).

10. The packaging and supply device for 3D printing materials according to claim 6, wherein an outer side wall of each of the snap-fit hose connector (31) and the threaded hose connector (32) is provided with a spare discharge port (40).
